(19) United States
(12) Patent Application Publication
(10) Pub. No.: US 2024/0103900 A1
(43) Pub. Date: Mar. 28, 2024

(54) ISOLATED EXECUTION MECHANISM FOR CROSS-PLATFORM HARDWARE MANAGEMENT AGENT

(71) Applicant: Dell Products L.P., Round Rock, TX (US)

(72) Inventors: Bo WANG, Shanghai (CN); Zhuo ZHANG, Shanghai (CN); Zhen CAO, Shanghai (CN); Haitao LUO, Shanghai (CN)

(73) Assignee: Dell Products L.P., Round Rock, TX (US)

(21) Appl. No.: 17/965,504

(22) Filed: Oct. 13, 2022

(30) Foreign Application Priority Data
Sep. 26, 2022 (CN) 202211180449.1

(51) Int. Cl. G06F 9/455; G06F 13/42

(52) U.S. Cl. CPC G06F 9/45558; G06F 13/4221; G06F 2009/45579

(57) ABSTRACT

A disclosed method initializes a sideband management (SBM) bridge coupled to a system bus of an information handling system to identify an operating system (OS) domain resource, e.g., a hardware component or an OS resource, as a sideband-manageable resource. An OS-isolated environment, e.g., a virtual machine (VM) or rootless container, may then be associated with the SBM bridge. Thereafter, the OS domain resource may be managed from the OS-isolated environment via the SBM bridge. The system bus may be a peripheral component interconnect express (PCIe) bus and the SBM bridge may be a PCIe bridge. The SBM bridge may include a single root I/O virtualization (SR-IOV) interface and initializing the SBM bridge may include initializing, by the OS domain resource, a physical function (PF) of the SBM bridge. In such embodiments, associating the OS-isolated object with the SBM bridge may include assigning a virtual function (VF) of the SBM bridge to the OS-isolated object.

### TECHNICAL FIELD

The present disclosure relates to virtualized computing systems and, more specifically, resources for managing virtualized computing systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Virtualization and containerization are prevailing technologies for delivering platform independent application software. Secure implementations of virtualized and container resources generally prohibit direct access to hardware and other system resources. While some bare metal container deployments may support at least some hardware management in an unsecured privileged mode, such deployments are still tightly coupled with the host operating system (OS).

Whether implemented with an agent-based or agentless design, hardware management generally requires privileged access, which could expose the host OS to incoming traffic or agent software installation. In addition, because both agent-based and agentless hardware management solutions are typically hardware-specific, OS specific, or both, developers of such solutions must devote significant effort to support multiple host OS platforms for the same functionality.

### SUMMARY

Subject matter disclosed herein addresses common problems associated with implementing hardware management from OS-isolated environments by enabling virtual machines (VMs), rootless containers, and other OS-isolated environments to invoke platform-independent agent software for performing hardware management on system hardware and OS resources, collectively referred to herein as OS domain resources, without exposing unprotected hardware access or host OS privileged rights to the agent. The agent software, which can also run on any host OS configured to support disclosed features, can be thinner and more secure than conventional, platform dependent hardware management solutions.

In one aspect, disclosed systems and methods initialize a sideband management (SBM) bridge coupled to a system bus of an information handling system to identify an operating system (OS) domain resource, e.g., a hardware component or an OS resource, as a sideband-manageable resource. An OS-isolated environment, e.g., a VM or rootless container, may then be associated with the SBM bridge. Thereafter, the OS domain resource may be managed from the OS-isolated environment via the SBM bridge.

In at least some embodiments, the system bus may be a peripheral component interconnect express (PCIe) bus and the SBM bridge may be a PCIe bridge. The SBM bridge may include a single root I/O virtualization (SR-IOV) interface and initializing the SBM bridge may include initializing, by the OS domain resource, a physical function (PF) of the SBM bridge. In such embodiments, associating the OS-isolated object with the SBM bridge may include assigning a virtual function (VF) of the SBM bridge to the OS-isolated object. In some embodiments, the SBM bridge is configured to pass management component transport protocol (MCTP) messages among the OS-isolated object, the host OS, and the system bus. Managing the OS domain resource comprises invoking an agent of the OS-isolated environment to execute the hardware management software.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 diagrams a system suitable to support hardware management from OS-isolated resources in accordance with disclosed teachings;

FIG. 2 illustrates an exemplary configuration for implementing disclosed systems;

FIG. 3 illustrates a flow diagram of disclosed hardware management methods; and

FIG. 4 illustrates an exemplary information handling system suitable for use in conjunction with disclosed teachings.

### DETAILED DESCRIPTION

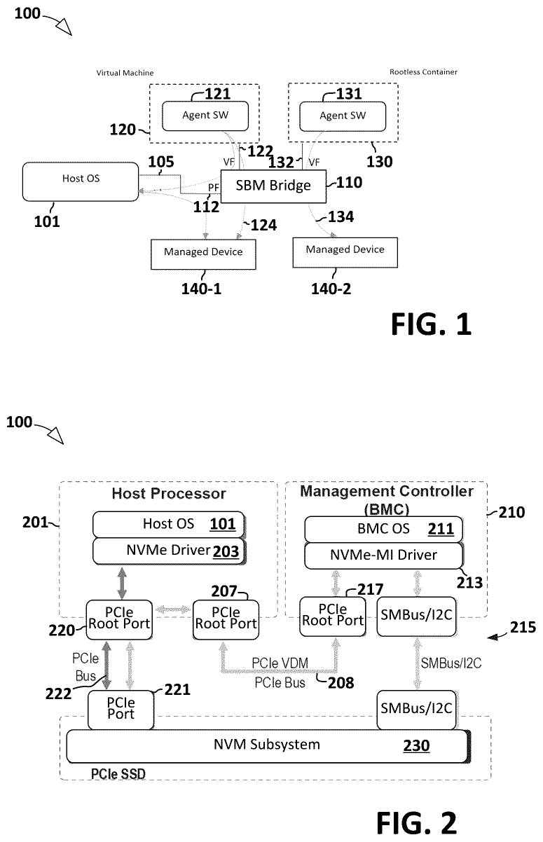

Exemplary embodiments and their advantages are best understood by reference to FIGS. 1-4, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates an information handling system 100 including support for disclosed methods for platform independent management of OS-domain resources with or from an isolated environment such as a VM or rootless container in accordance with disclosed teachings. The information handling system 100 illustrated in FIG. 1 includes a sideband management (SMB) bridge 110 shown coupled to a host OS 101 via a system bus 105. FIG. 1 further illustrates two examples of OS-isolated execution environments, including a VM 120 and a rootless container 130, as well as two examples of exemplary managed devices 140-1 and 140-2. Managed devices 140 may include storage devices, graphics processing units (GPUs), network interface controllers (NICs), host bus adapters (HBAs), and so forth.

SBM bridge 110 may be implemented as a PCIe bridge that includes SR-IOV support. SBM bridge 110 may be configured to forward management control messages including without limitation MCTP messages, between or among the OS-isolated resources (120, 130), host OS 101, and system bus 105. In accordance with SR-IOV, host OS 101 may initialize the physical function (PF) 112 of SBM bridge 110 to define or otherwise indicate OS domain devices, such as managed devices 140, that will be manageable from OS-isolated environments such as VM 120 and rootless container 130. After the PF is assigned, a VF of SBM-bridge 110 can be assigned to this isolated environment (a virtual machine or rootless container). The agent software can recognize this SBM-Bridge and run hardware management logics via such interface.

FIG. 1 also illustrates a VF 122 coupling SBM bridge 110 and VM 120 and a VF 132 coupling SBM bridge 110 and rootless container 130. FIG. 1 illustrates agent software 121 of VM 120 and agent software 131 of rootless container 130 controlling (124, 134) managed devices 140-1 and 140-2. In this manner, the illustrated system 100 enables OS-isolated resources such as VM 120 and rootless container 130 to manage OS-domain resources with platform agnostic agent software

Turning now to FIG. 2, an exemplary implementation of information handling system 100 suitable for use in conjunction with disclosed features for managing OS domain resources, such as the nonvolatile memory express (NVMe) subsystem 230 depicted in FIG. 2, from OS isolated environments is depicted. As depicted in FIG. 2 information handling system 100 includes a host processor 201 and a baseboard management controller (BMC) resource, identified simply as management controller 210. Host processor 201 is illustrated running a host OS 101 and an NVMe driver 203 while management controller 210 is illustrated running a BMC OS 211 and an NVMe management interface (NVMe-MI) driver 213. NVMe driver 203 is depicted in FIG. 2 coupled to NVM subsystem 230 via a PCIe bus 222 connected between a PCIe root port 220 on host processor 201 and a PCIe port 221 of NVM subsystem 230. The NVMe-MI driver 213 is illustrated in FIG. 2 coupled to NVM subsystem 230 via a system management bus (SMBus) connection 215 implemented with an I2C interconnect. FIG. 2 further illustrates a PCIe communication path between BMC 210 and host processor 201 via a PCIe interconnect 208 connecting a PCIe root port 207 of host processor 201 with a PCIe root port 217 of BMC 210.

The implementation of information handling system 100 as depicted in FIG. 2 is suitable to support an MCTP-over-PCIe VDM transport binding that defines a transport binding for facilitating communication between platform management subsystem components using PCIe Vendor Defined Messages (VDMs). Some devices and industry standards (such as NVMe-MI) can leverage the MCTP-over-PCIe VDM to provide the management interface to avoid the in-band software dependency. PCIe VDMs are separate from in-band PCIe traffic, though they share the same physical connection. This paradigm can be extended to other kinds of devices, such as GPU, NIC, HBA, etc.

Host OS 101 can also expose its capabilities to isolated agent software via SM-Bus. For example, the agent software can manipulate OS-owned resources, such as file systems, via the SM-Bridge channel. The interface of OS resource management on SM-Bridge occurs platform neutral and no third-party software needs to be installed on host OS. Compared to the traditional in-band management, root privilege is no longer needed, and no service is exposed to network on host OS.

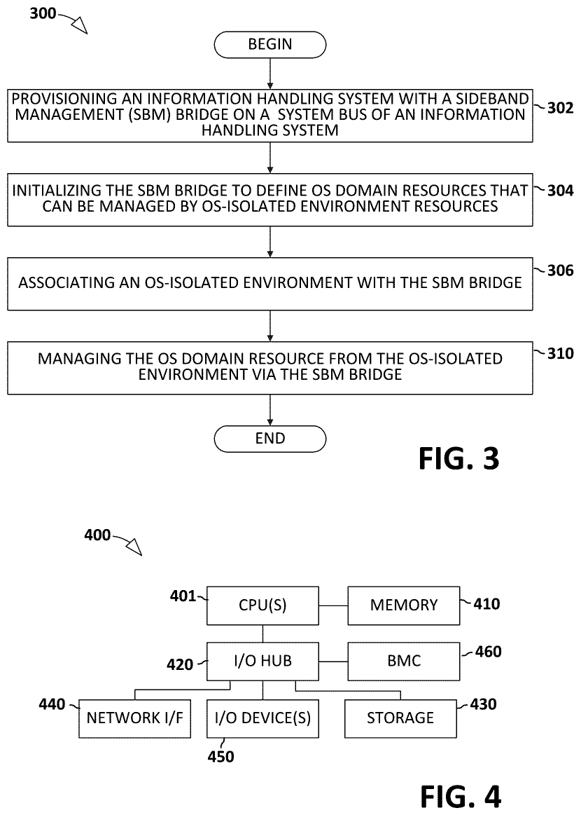

Referring now to FIG. 3, a flow diagram illustrates a method 300 for managing OS domain resources including hardware devices and OS resources, from OS-isolated environments such as the VM and rootless container of FIG. 4. The illustrated method 300 begins with the provisioning (operation 302) of an information handling system with an SBM bridge, such as the SBM bridge 110 of FIG. 1, coupled to a system bus of the information handling system. The illustrated method 300 then initializes (operation 304) the SBM bridge to identify OS domain resources as a sideband-manageable resource. In embodiments that include a PCIe device with SR-IOV interface support, the association between the OS-isolated resource and the SBM bridge may be implemented with a PCIe-compliant PF. The method 300 of FIG. 3 then associates (operation 306) an OS-isolated environment, such as the VM or rootless container illustrated in FIG. 1 with the SBM bridge. In embodiments that include an SR-IOV interface, the association between the OS-isolated resource and the SBM bridge may be implemented with a PCIe-compliant VF. After the OS isolated environment is associated with the SBM bridge, agent software running on the OS isolated environment may then manage (operation 310) or otherwise control one or more OS domain resources.

Referring now to FIG. 4, any one or more of the elements illustrated in FIG. 1 through FIG. 3 may be implemented as or within an information handling system exemplified by the information handling system 400 illustrated in FIG. 4. The illustrated information handling system includes one or more general purpose processors or central processing units (CPUs) 401 communicatively coupled to a memory resource 410 and to an input/output hub 420 to which various I/O resources and/or components are communicatively coupled. The I/O resources explicitly depicted in FIG. 4 include a network interface 440, commonly referred to as a NIC (network interface card), storage resources 430, and additional I/O devices, components, or resources 450 including as non-limiting examples, keyboards, mice, displays, printers, speakers, microphones, etc. The illustrated information handling system 400 includes a baseboard management controller (BMC) 460 providing, among other features and services, an out-of-band management resource which may be coupled to a management server (not depicted). In at least some embodiments, BMC 460 may manage information handling system 400 even when information handling system 400 is powered off or powered to a standby state. BMC 460 may include a processor, memory, an out-of-band network interface separate from and physically isolated from an in-band network interface of information handling system 400, and/or other embedded information handling resources. In certain embodiments, BMC 460 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
initializing a sideband management (SBM) bridge coupled to a system bus of an information handling system to identify an operating system (OS) domain resource as a sideband-manageable resource;
associating an OS-isolated environment with the SBM bridge; and
managing the OS domain resource from the OS-isolated environment via the SBM bridge.

2. The method of claim 1, wherein the system bus comprises a peripheral component interconnect express (PCIe) bus and the SBM bridge comprises a PCIe bridge.

3. The method of claim 2, wherein the SBM bridge includes a single root I/O virtualization (SR-IOV) interface and wherein initializing the SBM bridge comprises initializing, by the OS domain resource, a physical function (PF) of the SBM bridge.

4. The method of claim 3, wherein associating the OS-isolated environment with the SBM bridge comprises assigning a virtual function (VF) of the SBM bridge to the OS-isolated environment.

5. The method of claim 1, wherein the OS-isolated environment comprises a virtual machine (VM).

6. The method of claim 1, wherein the OS-isolated environment comprises a rootless container.

7. The method of claim 1, wherein the SBM bridge is configured to pass management component transport protocol (MCTP) messages among the OS-isolated environment, the host OS, and the system bus.

8. The method of claim 1, wherein managing the OS domain resource comprise invoking an agent of the OS-isolated environment to execute the hardware management software.

9. An information handling system, comprising:
a central processing unit (CPU); and
a memory, accessible to the CPU, including processor executable program instructions that, when executed by the CPU, cause the system to perform operations including:
initializing a sideband management (SBM) bridge coupled to a system bus of an information handling system to identify an operating system (OS) domain resource as a sideband-manageable resource;
associating an OS-isolated environment with the SBM bridge; and
managing the OS domain resource from the OS-isolated environment via the SBM bridge.

10. The information handling system of claim 9, wherein the system bus comprises a peripheral component interconnect express (PCIe) bus and the SBM bridge comprises a PCIe bridge.

11. The information handling system of claim 10, wherein the SBM bridge includes a single root I/O virtualization (SR-IOV) interface and wherein initializing the SBM bridge comprises initializing, by the OS domain resource, a physical function (PF) of the SBM bridge.

12. The information handling system of claim 11, wherein associating the OS-isolated object with the SBM bridge comprises assigning a virtual function (VF) of the SBM bridge to the OS-isolated environment.

13. The information handling system of claim 9, wherein the OS-isolated environment comprises a virtual machine (VM).

14. The information handling system of claim 9, wherein the OS-isolated environment comprises a rootless container.

15. The information handling system of claim 9, wherein the SBM bridge is configured to pass management component transport protocol (MCTP) messages among the OS-isolated environment, the host OS, and the system bus.

16. The information handling system of claim 9, wherein managing the OS domain resource comprise invoking an agent of the OS-isolated environment to execute the hardware management software.
